(19) United States
(12) Patent Application Publication
(10) Pub. No.: US 2024/0122232 A1
(43) Pub. Date: Apr. 18, 2024

(54) Aerosol Generating Device

(71) Applicant: JT International SA, Geneva (CH)

(72) Inventor: Eduardo Jose Garcia Garcia, Grand-Saconnex (CH)

(73) Assignee: JT International SA, Geneva (CH)

(21) Appl. No.: 18/274,619

(22) PCT Filed: Jan. 27, 2022
(86) PCT No.: PCT/EP2022/051863

§ 371 Date: Jul. 27, 2023

(30) Foreign Application Priority Data
Feb. 2, 2021 (EP) 21154690.8

(51) Int. Cl. A24D 1/20; A24C 5/01; A24F 40/20; A24F 40/465; H05B 6/10

(52) U.S. Cl. CPC A24D 1/20; A24C 5/01; A24F 40/20; A24F 40/465; H05B 6/108

(57) ABSTRACT

An aerosol generating article includes a first layer of aerosol generating material; a second layer of aerosol generating material; and a plurality of strips of inductively heatable susceptor material; wherein each of the strips of inductively heatable susceptor material is located between the first and second layer of aerosol generating material.

### FIELD OF INVENTION

The present disclosure relates generally to aerosol generating articles, and more particularly to an aerosol generating article for use with an aerosol generating device for heating the aerosol generating article to generate an aerosol for inhalation by a user. The present disclosure is particularly applicable to aerosol generating articles for use with a portable (hand-held) aerosol generating device.

### BACKGROUND

The popularity and use of reduced-risk or modified-risk devices (also known as aerosol generating devices or vapour generating devices) has grown rapidly in recent years as an alternative to the use of traditional tobacco products. Various devices and systems are available that heat or warm aerosol generating substances to generate an aerosol for inhalation by a user.

A commonly available reduced-risk or modified-risk device is the heated substrate aerosol generating device, or so-called heat-not-burn device. Devices of this type generate an aerosol or vapour by heating an aerosol generating substrate to a temperature typically in the range 150° C. to 300° C. Heating the aerosol generating substrate to a temperature within this range, without burning or combusting the aerosol generating substrate, generates a vapour which typically cools and condenses to form an aerosol for inhalation by a user of the device.

Currently available aerosol generating devices can use one of a number of different approaches to provide heat to the aerosol generating substrate. One such approach is to provide an aerosol generating device which employs an induction heating system. In such a device, an induction coil is provided in the device and an inductively heatable susceptor is provided to heat the aerosol generating substrate. Electrical energy is supplied to the induction coil when a user activates the device which in turn generates an alternating electromagnetic field. The susceptor couples with the electromagnetic field and generates heat which is transferred, for example by conduction, to the aerosol generating substrate and an aerosol is generated as the aerosol generating substrate is heated.

It would be desirable to provide an aerosol generating article which enables efficient heat transfer by the induction heating system to the aerosol generating substrate.

### SUMMARY OF INVENTION

According to a first aspect there is provided an aerosol generating article comprising a first layer of aerosol generating material, a second layer of aerosol generating material, and a plurality of strips of inductively heatable susceptor material. Each of the strips of inductively heatable susceptor material is located between the first and second layer of aerosol generating material.

Placing the strips of inductively heatable susceptor material between the first and second layer of aerosol generating material provides effective heat transfer from the susceptor material to the aerosol generating material during use of the aerosol generating article in an aerosol generating device. This in turn provides effective and uniform heating of the aerosol generating material and, thus, reliable vapour generation. Aerosol generating articles according to the present disclosure can also be manufactured efficiently, and mass produced with relative ease.

Furthermore, by surrounding the susceptor material by the aerosol generating material, there is reduced risk of having the susceptor material coming into contact with the tobacco wrapping paper, which may cause damage to the aerosol generating article.

The plurality of strips of inductively heatable susceptor material located between the first and second layer of aerosol generating material are arranged as a sheet.

The sheet may be a continuous sheet. This may facilitate manufacture of the aerosol generating article.

Preferably, the sheet comprises a first surface having a plurality of raised portions. The first surface of the sheet may also comprise a plurality of lowered portions. The raised and lowered portions may be alternatively arranged on the sheet. Preferably, the raised portions correspond to a part of the sheet comprising a strip of inductively heatable susceptor material. This arrangement may have the effect that the strips of inductively heatable susceptor material can be thought of as embedded within the first and second layers of aerosol generating material. This may allow an aerosol or vapour to be generated more effectively because the strips of inductively heatable susceptor material are fully surrounded by the layers of aerosol generating material and, therefore, heat transfer from the strips of inductively heatable susceptor material to the layers of aerosol generating material is maximised.

In some developments, the sheet may be arranged as a spiral helping to ensure sufficient air flow around the sheet so that the generated vapour may move freely out of the aerosol generating article during inhalation with limited obstruction.

In some other developments, the sheet may comprise at least two sheet layers, wherein each sheet layer comprises at least two strips of inductively heatable susceptor material located between the first and second layer of aerosol generating material. Each of the sheet layers may be arranged as a ring. Preferably, the rings of sheet layers may be concentrically arranged. This may ensure there is sufficient air flow around the sheet layers allowing the generated vapour to move freely out of the aerosol generating article during inhalation.

In further developments, the sheet may comprise a plurality of sheet segments, wherein each sheet segment comprises at least one strip of inductively heatable susceptor material located between a first and second layer of aerosol generating material. Preferably, each of the sheet segments are separate from each other, which may help improve air flow around the sheet segments.

Each of the sheet segments may be randomly arranged within the aerosol generating device. The plurality of sheet segments may have a plurality of different orientations within the cross-section of the aerosol generating article. This may help to ensure a uniform heat transfer from strips of inductively heatable susceptor material to the layers of aerosol generating material and, thus, allow a maximum amount of vapour to be generated during use of the aerosol generating article.

Preferably, the aerosol generating material comprises a tobacco material. This may facilitate manufacture of the aerosol generating article and may also allow a maximum amount of vapour to be generated during use of the aerosol generating article due to heating of both the first and second layers of aerosol generating material by heat transferred from the strips of inductively heatable susceptor material.

The aerosol generating material may be any type of solid or semi-solid material. Example types of aerosol generating solids include powder, granules, pellets, shreds, strands, particles, gel, strips, loose leaves, cut leaves, cut filler, porous material, foam material or sheets. The aerosol generating material may comprise plant-derived material and in particular, may comprise a tobacco. It may advantageously comprise reconstituted tobacco, for example including tobacco and any one or more of cellulose fibres, tobacco stalk fibres and inorganic fillers such as CaCO3. Consequently, the aerosol generating device with which the aerosol generating articles are intended for use may be referred to as a “heated tobacco device”, a “heat-not-burn tobacco device”, a “device for vapourising tobacco products”, and the like, with this being interpreted as a device suitable for achieving these effects. The features disclosed herein are equally applicable to devices which are designed to vapourise any aerosol generating substrate.

In some examples, a length of each of the first and second layers of aerosol generating material may be equal to a length of each of the strips of inductively heatable susceptor material. This may facilitate vapour generation and manufacture of the aerosol generating article.

The inductively heatable susceptor material may comprise a metal, preferably selected from the stainless steel and carbon steel. The inductively heatable susceptor material could, however, comprise any suitable material including one or more of, but not limited to, aluminium, iron, nickel, stainless steel, carbon steel, and alloys thereof, e.g. Nickel Chromium or Nickel Copper. With the application of an electromagnetic field in its vicinity during use of the aerosol generating article in an aerosol generating device, the strips of susceptor material may generate heat due to eddy currents and magnetic hysteresis losses resulting in a conversion of energy from electromagnetic to heat.

Each of the strips of inductively heatable susceptor material may have a thickness between 1 μm and 500 μm, preferably between 10 μm and 100 μm, more preferably approximately 50 μm. Strips of susceptor material having these thickness dimensions may be particularly suitable for being inductively heated during use of the aerosol generating article and may also facilitate manufacture of the aerosol generating article.

The first and/or second layers of aerosol generating material may have a thickness between 50 μm and 500 μm, preferably between 150 μm and 300 μm, more preferably approximately 220 μm.

The aerosol generating article may be circumscribed by a paper wrapper.

The aerosol generating article may be formed substantially in the shape of a stick, and may broadly resemble a cigarette, having a tubular region with an aerosol generating substrate arranged in a suitable manner. The aerosol generating article may include a filter segment, for example comprising cellulose acetate fibres, at a proximal end of the aerosol generating article. The filter segment may constitute a mouthpiece filter and may be in coaxial alignment with an aerosol generating substrate comprising susceptor material and aerosol generating material. One or more vapour collection regions, cooling regions, and other structures may also be included in some designs. For example, the aerosol generating article may include at least one tubular segment upstream of the filter segment. The tubular segment may act as a vapour cooling region. The vapour cooling region may advantageously allow the heated vapour generated by heating the aerosol generating material to cool and condense to form an aerosol with suitable characteristics for inhalation by a user, for example through the filter segment.

The aerosol generating material may comprise an aerosol-former. Examples of aerosol-formers include polyhydric alcohols and mixtures thereof such as glycerine or propylene glycol. Typically, the aerosol generating material may comprise an aerosol-former content of between approximately 5% and approximately 50% on a dry weight basis. In some embodiments, the aerosol generating material may comprise an aerosol-former content of between approximately 10% and approximately 20% on a dry weight basis, and possibly approximately 15% on a dry weight basis.

Upon heating, the aerosol generating material may release volatile compounds. The volatile compounds may include nicotine or flavour compounds such as tobacco flavouring.

According to another aspect there is provided an aerosol generating device comprising an aerosol generating article according to any of the above described aerosol generating articles.

According to another aspect there is provided a method of producing an aerosol generating article comprising the step of arranging a plurality of strips of inductively heatable susceptor material between a first and a second layer of aerosol generating material.

The method preferably comprises the steps of applying an adhesive to the plurality of strips of inductively heatable susceptor material, locating the plurality of strips of inductively heatable susceptor material between the first and second layers of aerosol generating material, and pressing the first and second layers together to form a sheet.

In some examples, the sheet may be cut into a plurality of sheet segments, wherein each sheet segment comprises at least one strip of inductively heatable susceptor material located between a first and second layer of aerosol generating material.

In other examples, the sheet may be cut into at least two sheet layers, wherein each sheet layer comprises at least two strips of inductively heatable susceptor material located between the first and second layer of aerosol generating material.

### BRIEF DESCRIPTION OF DRAWINGS

Embodiments of the present invention will now be described by way of example only with reference to the accompanying drawings in which:

FIG. 1a is a diagrammatic cross-sectional side view of an aerosol generating 15 article;

FIG. 1b is a cross-sectional view along the line A-A in FIG. 1a, in a first example of an aerosol generating article;

FIG. 1c is a cross-sectional view along the line A-A in FIG. 1a, in a second example of an aerosol generating article;

FIG. 2 is a diagrammatic illustration of an apparatus and method for manufacturing the aerosol generating article;

FIG. 3 is a plan view of a section of a continuous web of susceptor material showing adhesive areas and non-adhesive areas;

FIG. 4 is a functional illustration of part of the apparatus and method of FIG. 2 schematically illustrating the formation of inductively heatable susceptor strips and the application of the inductively heatable susceptor strips to a surface of aerosol generating material;

FIG. 5a is a functional illustration of a method of forming an aerosol generating article; and

FIG. 5b is a functional illustration of another method of forming an aerosol generating article.

### DETAILED DESCRIPTION

The aerosol generating article described herein is for use with an aerosol generating device for heating the aerosol generating material, without burning the aerosol generating material, to volatise at least one component of the aerosol generating material and thereby generate a heated vapour which cools and condenses to form an aerosol for inhalation by a user of the aerosol generating device. The aerosol generating device is a hand-held, portable, device.

In general terms, a vapour is a substance in the gas phase at a temperature lower than its critical temperature, which means that the vapour can be condensed to a liquid by increasing its pressure without reducing the temperature, whereas an aerosol is a suspension of fine solid particles or liquid droplets, in air or another gas. It should, however, be noted that the terms ‘aerosol’ and ‘vapour’ may be used interchangeably in this specification, particularly with regard to the form of the inhalable medium that is generated for inhalation by a user.

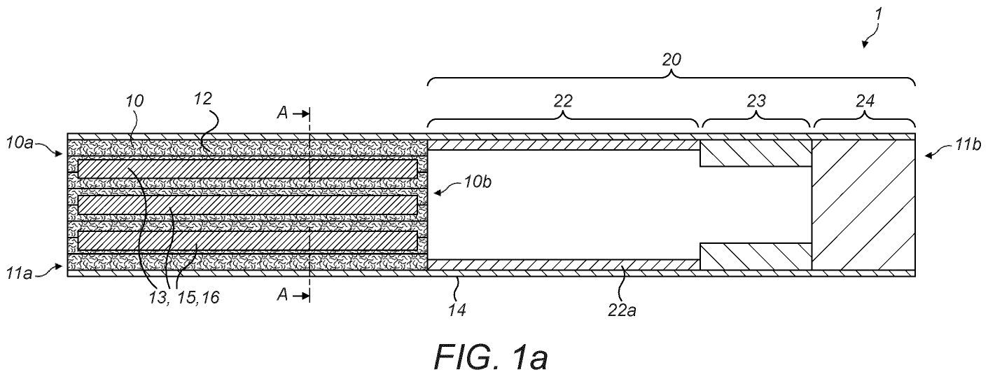

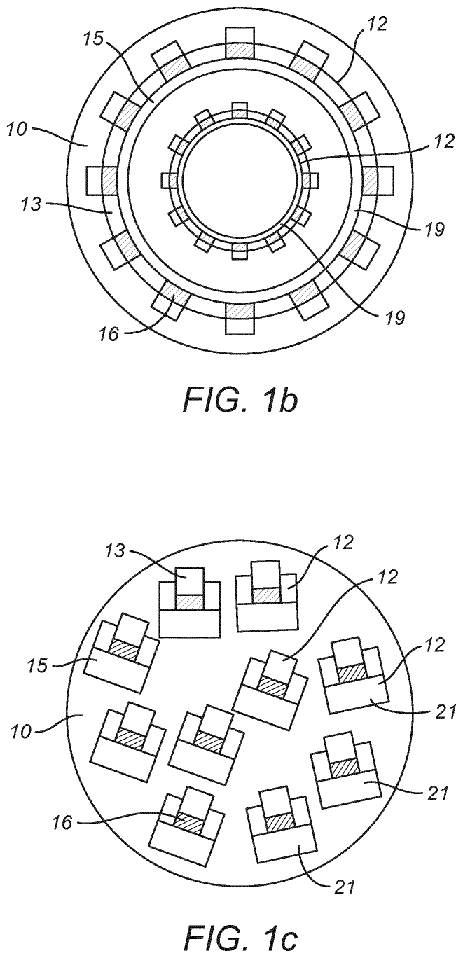

Referring initially to FIG. 1a, there is shown an aerosol generating article 1 for use with an aerosol generating device that comprises an induction heating system to inductively heat the aerosol generating article 1 and thereby generate an aerosol for inhalation by a user of the device. Such devices are known in the art and will not be described in further detail in this specification. The aerosol generating article 1 is elongate, having a distal end 11a and a proximal end (or mouth end) 11b, and is substantially cylindrical. The circular cross-section facilitates handling of the article 1 by a user and insertion of the article 1 into a cavity or heating compartment of an aerosol generating device.

The aerosol generating article 1 comprises an aerosol generating substrate 10 having first and second ends 10a, 10b and inductively heatable susceptor portion 12. The aerosol generating substrate 10 and the inductively heatable susceptor portion 12 are positioned in, and enclosed by, a wrapper 14. The wrapper 14 comprises a material that is substantially non-electrically conductive and non-magnetically permeable. In the illustrated example, the wrapper 14 is a paper wrapper and may comprise cigarette paper.

The inductively heatable susceptor portion 12 comprises a first layer of aerosol generating material 15, a second layer of aerosol generating material 13, and a plurality of strips of inductively heatable susceptor material 16, as shown in FIGS. 1b and 1c. Each of the strips of inductively heatable susceptor material 16 is located between the first and second layers 15, 13 of aerosol generating material. In other words, the plurality of strips of inductively heatable susceptor material 16 can be thought of as being sandwiched between the first and second layer 15, 13 of aerosol generating material. This is achieved by the plurality of strips of inductively heatable susceptor material 16 being adhered to both the first and second layers 15, 13 of aerosol generating material. In this way, the plurality of strips of inductively heatable susceptor material 16 located between the first and second layer 15, 13 of aerosol generating material are arranged to form a sheet. That is, the inductively heatable susceptor portion 12 has a sheet-like structure.

The sheet of inductively heatable susceptor portion 12 forms part of the aerosol generating substrate 10 and is arranged to form a substantially rod-shaped aerosol generating article 1. The inductively heatable susceptor portion 12 is arranged substantially oriented in a longitudinal direction of the aerosol generating article 1. The sheet of inductively heatable susceptor portion 12 is typically foldless in the longitudinal direction to ensure that the airflow route through the aerosol generating article 1 is not interrupted and that a uniform air flow through the article 1 can be achieved.

The first layer of aerosol generating material 15, the second layer of aerosol generating material 13, and the plurality of strips of inductively heatable susceptor material 16 all have substantially the same height. In this case, height refers to a distance in a longitudinal direction of the aerosol generating article 1.

The arrangement of the inductively heatable susceptor portion 12 within the aerosol generating article 1 will now be described in more detail, with reference to FIGS. 1b and 1c.

In a first example arrangement the inductively heatable susceptor portion 12 is arranged as a spiral within the aerosol generating substrate 10. The spiral is located substantially centrally within the aerosol generating substrate 10, and the spiral is substantially co-axially aligned with the aerosol generating article 1.

In a second example, shown in FIG. 1b the sheet of inductively heatable susceptor portion 12 is divided into at least two parts 19, which may be referred to as inductively heatable susceptor sheet layers 19. Each sheet layer 19 comprises at least two strips of inductively heatable susceptor material 16 located between the first and second layer of aerosol generating material 15, 13. In this way, each sheet layer 19 has a similar construction to the inductively heatable susceptor portion 12 but it has fewer strips of inductively heatable susceptor material 16. Each of the sheet layers 19 is arranged as a ring, as shown in FIG. 1b, and the plurality of rings are concentrically arranged within the aerosol generating substrate 10. The rings of the sheet layers 19 are co-axially aligned with the aerosol generating article 1. Although the example shown in FIG. 1b illustrates two concentric rings, it will be understood that more than two rings may be provided.

In a third example, shown in FIG. 1c, the inductively heatable susceptor portion 12 is divided into a plurality of parts 21, which may be referred to as inductively heatable susceptor sheet segments 21. Each sheet segment 21 comprises at least one strip of inductively heatable susceptor material 16 located between the first and second layer of aerosol generating material 15, 13.

Although the example shown in FIG. 1c illustrates each sheet segment 21 having one strip of inductively heatable susceptor material 16, it will be understood that some sheet segments may have two or more strip of inductively heatable susceptor material 16. Each of the sheet segments are discreet and separate from each other, as shown in FIG. 1c. The sheet segments 21 can be randomly distributed throughout the cross-section of the rod-shaped aerosol generating article 1 such that they have a plurality of different orientations within the cross-section of the aerosol generating article 1, as shown in FIG. 1c. In this way, the sheet segments 21 are randomly arranged and orientated with the aerosol generating substrate 10.

All of the above described arrangements advantageously provide aerosol generating material which surrounds each inductively heater susceptor strip. Having multiple susceptors being surrounded by tobacco material means that there is no risk of any of the susceptors coming into contact with the tobacco wrapping paper. This reduces the chance of the susceptors burning or damaging the wrapping paper.

In addition, by having each susceptor surround by tobacco material, each susceptor is only heating the amount of tobacco material that it is in direct contact with. This maximizes heat and energy efficiency by reducing heat propagation through the aerosol generating substrate 10. This also helps limit the maximum temperature required to heat the whole stick as less energy is wasted.

A further advantage of the above described arrangements is that air channels are formed between each susceptor structure (i.e. the spiral, the sheet layers, and the sheet segments) which allows the generated vapour to move towards the filter with minimal obstruction.

Looking back at FIG. 1a, the aerosol generating article 1 comprises a mouthpiece segment 20 positioned downstream of the aerosol generating substrate 10. The aerosol generating substrate 10 and the mouthpiece segment 20 are arranged in coaxial alignment inside the wrapper 14 to hold the components in position to form the rod-shaped aerosol generating article 1.

In the illustrated embodiment, the mouthpiece segment 20 comprises the following components arranged sequentially and in co-axial alignment in a downstream direction, in other words from the distal end 11a to the proximal (mouth) end llb of the aerosol generating article 1: a cooling segment 22, a center hole segment 23 and a filter segment 24. The cooling segment 22 comprises a hollow paper tube 22a having a thickness which is greater than the thickness of the paper wrapper 14. The center hole segment 23 may comprise a cured mixture containing cellulose acetate fibres and a plasticizer, and functions to increase the strength of the mouthpiece segment 20. The filter segment 24 typically comprises cellulose acetate fibres and acts as a mouthpiece filter. As heated vapour flows from the aerosol generating substrate 10 towards the proximal (mouth) end 11b of the aerosol generating article 1, the vapour cools and condenses as it passes through the cooling segment 22 and the center hole segment 23 to form an aerosol with suitable characteristics for inhalation by a user through the filter segment 24.

The first and second layers 15, 13 of the aerosol generating material comprise a tobacco material. The first and second layers of aerosol generating material 15, 13 can advantageously comprise reconstituted tobacco including tobacco and any one or more of cellulose fibres, tobacco stalk fibres and inorganic fillers such as CaCO3.

The first and second layers 15, 13 of the aerosol generating material typically comprise an aerosol-former such as glycerine or propylene glycol. Typically, the first and second layers 15, 13 of the aerosol generating material comprise an aerosol-former content of between approximately 5% and approximately 50% on a dry weight basis. Upon heating, the first and second layers 15, 13 of the aerosol generating material release volatile compounds possibly including nicotine or flavour compounds such as tobacco flavouring.

When a time varying electromagnetic field is applied in the vicinity of the plurality of strips of inductively heatable susceptor material 16 during use of the article 1 in an aerosol generating device, heat is generated in the plurality of strips of inductively heatable susceptor material 16 due to eddy currents and magnetic hysteresis losses. The heat is transferred from the plurality of strips of inductively heatable susceptor material 16 to the first and second layers 15, 13 of the aerosol generating material to heat the first and second layers 15, 13 of the aerosol generating material without burning them to release one or more volatile compounds and thereby generate a vapour. As a user inhales through the filter segment 24, the heated vapour is drawn in a downstream direction through the article 1 from the first end 10a of the aerosol generating substrate 10 towards the second end 10b of the aerosol generating substrate 10, and towards the filter segment 24. As noted above, as the heated vapour flows through the cooling segment 22 and the center hole segment 23 towards the filter segment 24, the heated vapour cools and condenses to form an aerosol with suitable characteristics for inhalation by a user through the filter segment 24.

Apparatus 30 and methods suitable for manufacturing aerosol generating articles according to the present disclosure will now be described.

Briefly, the method involves arranging the plurality of strips of inductively heatable susceptor material 16 between the first and a second layers 15, 13 of aerosol generating material. An adhesive is applied to the strips of inductively heatable susceptor material 16 and, after locating the plurality of strips of inductively heatable susceptor material 16 between the first and second layers of aerosol generating material 15, 13, the first and second layers of aerosol generating material 15, 13 are pressed together to form the inductively heatable susceptor portion 12, having the form of a sheet. In the case of the second and third examples described previously, the sheet is cut into a number of parts before the aerosol generating article 1 is assembled.

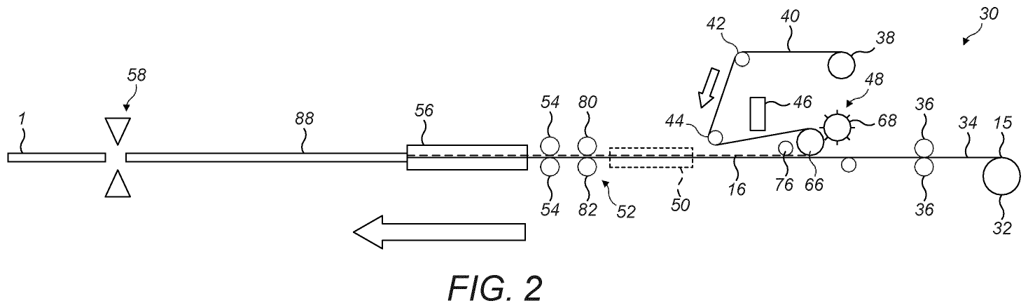

Further details of the apparatus and method for manufacturing the aerosol generating article 1 will now be described, with reference to FIG. 2.

The apparatus 30 comprises a supply reel 32 (e.g. a first bobbin) which carries a continuous web 34 of an aerosol generating material 15 having a substantially flat surface and first feed rollers 36 for controlling the feed of the continuous web 34 of aerosol generating material 15. The apparatus 30 also comprises a second supply reel 33 (e.g. a second bobbin) which carries a second continuous web of aerosol generating material 13. For clarity, this second supply reel 33 and second continuous web of an aerosol generating material 13 is not shown in FIG. 2.

The apparatus 30 comprises a susceptor supply reel 38 (e.g. a third bobbin) which carries a continuous web 40 of susceptor material, feed rollers 42, 44 for controlling the feed of the continuous web 40 of susceptor material, adhesive applicator units 46, and a susceptor cutting unit 48. For clarity, FIG. 2 only shows one adhesive applicator unit 46, arranged to apply adhesive to a first side of the susceptor material. Another adhesive applicator unit (not shown) is arranged to apply adhesive to the other side of the susceptor material.

The apparatus 30 further comprises an optional heater 50, a strip cutting unit 52, feed rollers 54, a rod forming unit 56, and a rod-cutting unit 58.

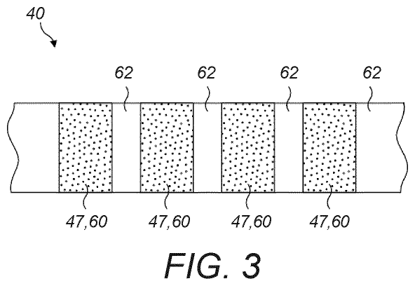

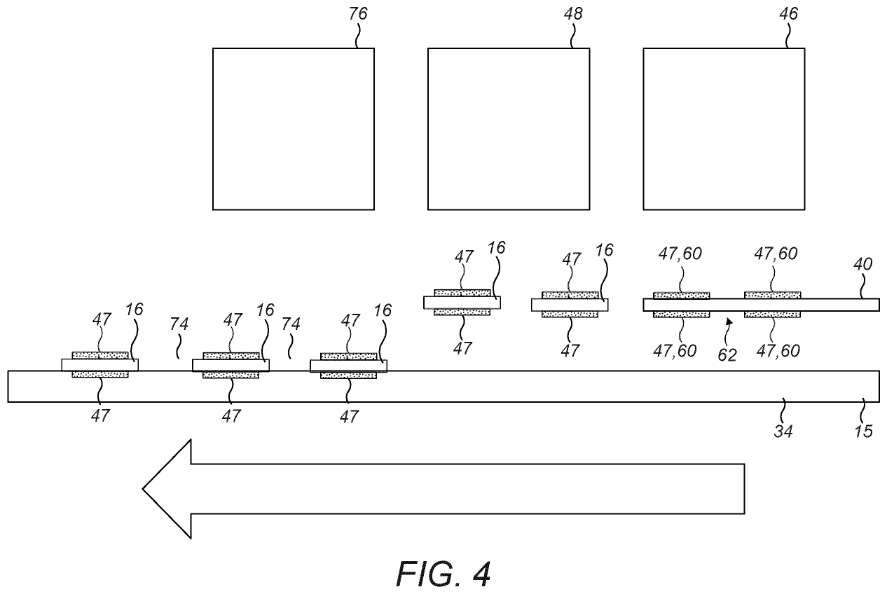

In operation, a first continuous web 34 of aerosol generating material 15 is continuously supplied from the supply reel 32 and a second continuous web of aerosol generating material 13 is continuously supplied from the second supply reel. At the same time, a continuous web 40 of susceptor material is continuously supplied from the susceptor supply reel 38, via the feed rollers 42, 44, to the adhesive applicator units 46. The adhesive applicator units 46 apply an adhesive 47 to both sides (i.e. a top side and a bottom side) of the continuous web 40 of susceptor material. In the illustrated example, the adhesive applicator unit 46 applies the adhesive 47 to the surfaces of the continuous web 40 of susceptor material intermittently, and across the full width of the web 40. In this way, discrete adhesive areas 60 (see FIGS. 3 and 4) are formed on the surfaces of the continuous web 40 of susceptor material, with adhesive-free areas 62 being formed between adjacent adhesive areas 60 in the direction of travel of the continuous web 40 of susceptor material 16.

The continuous web 40 of susceptor material is supplied from the adhesive applicator units 46 to the susceptor cutting unit 48 which continuously cuts the continuous web 40 of susceptor material to form a plurality of strips of inductively heatable susceptor material 16. The susceptor cutting unit 48 a support drum 66 and a cutting drum 68. The support drum 66 supports the continuous web 40 of susceptor material around its periphery. The cutting drum 68 includes a plurality of circumferentially spaced cutting elements, for example projecting cutting blades, around its periphery and the cutting elements cooperate with (e.g., extend into) circumferentially spaced recesses around the periphery of the support drum 66. This results in continuous shear cutting of the continuous web 40 of susceptor material to form the plurality of strips of inductively heatable susceptor material 16.

In order to minimise soiling of the susceptor cutting unit 48 by the adhesive 47 applied to the continuous web 40 of susceptor material by the adhesive applicator units 46, the susceptor cutting unit 48 cuts the continuous web 40 of susceptor material in the adhesive-free areas 62, that is at positions between the adhesive areas 60 on the surface of the continuous web 40 of susceptor material. This can be achieved by synchronising the operation of the susceptor cutting unit 48 with the movement of the continuous web 40 of susceptor material.

The plurality of strips of inductively heatable susceptor material 16 provided by the susceptor cutting unit 48 are positioned between a surface of each of the first and second continuous webs 34 of aerosol generating material 15, 13 so that there is a constant and predetermined spacing 74 between the edges of each successive strip of inductively heatable susceptor material 16, for example as shown in FIG. 4. In order to ensure that there is adequate adhesion between the of strips of inductively heatable susceptor material 16 and the substantially flat surface of the first and second continuous webs 34 of aerosol generating material 15, 13, the strips of inductively heatable susceptor material 16 are pressed between the first and second aerosol generating materials 15, 13 by a cam roller 76 which applies a compressive force to the first and second aerosol generating materials 15, 13, shown diagrammatically in FIG. 2, to form inductively heatable susceptor portion 12, having a sheet-like structure.

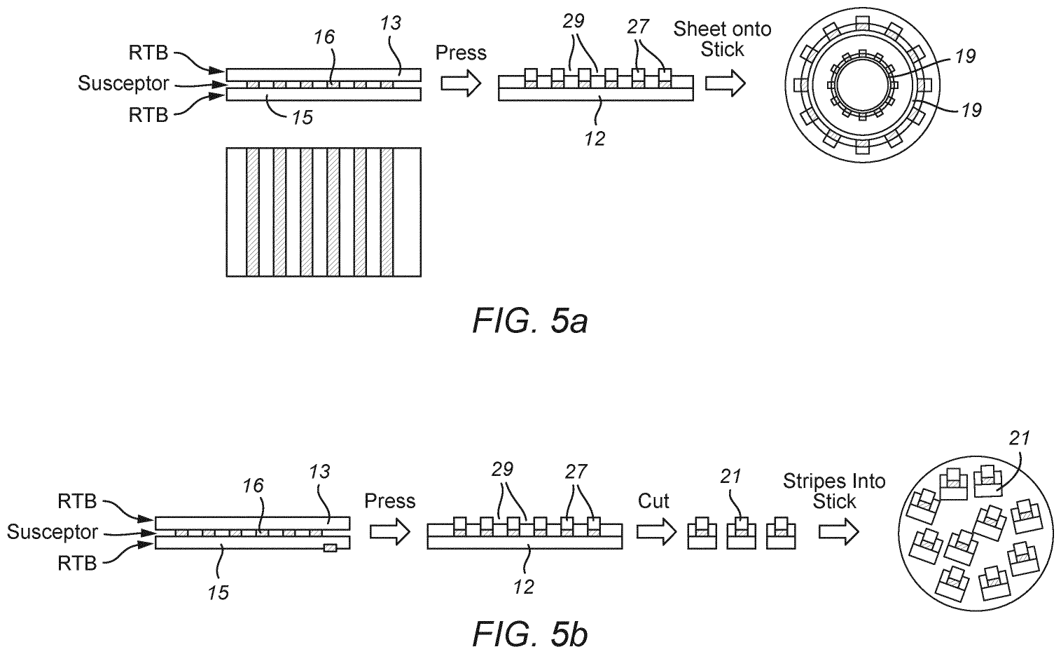

Since the plurality of strips of susceptor material 16 are spaced apart by a gap 74, after the first and second layers of aerosol generating material 15, 13 have been pressed together one surface of the inductively heatable susceptor portion 12 will have an alternating raised and lowered (e.g. undulating) structure, as shown in FIGS. 5a and 5b. The raised part 27 of the surface corresponds to the part of the inductively heatable susceptor portion 12 comprising the strips of inductively heatable susceptor material 16 and the lowered part 29 of the surface corresponds to the gaps between the strips of inductively heatable susceptor material 16. This arrangement provides very close contact between the strips of inductively heatable susceptor material 16 and the first and second layers of aerosol generating material 15, 13, which helps contribute to increased vapour generation due to the close contact and increased surface area between the inductively heatable susceptor material 16 and the aerosol generating material 15, 13. In addition, the lowered portion 29 between each strip of inductively heatable susceptor material 16, where the first and second layer of aerosol generating material 15, 13 are in contact with each other, minimises the likelihood of contact between the strips of inductively heatable susceptor material 16.

As can be seen, when the upper layer of aerosol generating material 13 is pressed against the rigid strips of susceptor material 16, the part of the upper layer of aerosol generating material 13 corresponding to these strips deforms and forms a raised structure 27 compared to the other areas. These raised parts 27 can also be referred to as concave portions of the inductively heatable susceptor portion 12.

In some examples, the first and second aerosol generating materials 15, 13 and the strips of inductively heatable susceptor material 16 adhered to the surfaces thereof can be heated by the optional heater 50. This may help to cure or set the adhesive 47, and thereby ensure a good bond between each strip of inductively heatable susceptor material 16 and the surfaces of the aerosol generating material 15, 13.

The sheet of inductively heatable susceptor portion 12 is fed to the strip cutting unit 52 which cuts the continuous sheet of the inductively heatable susceptor portion 12. The strip cutting unit 52 of FIG. 2 comprises first and second cutting drums 80, 82 each having first and second cutting formations 84, 86 which cooperate (e.g., intermesh) to shear cut the sheet of inductively heatable susceptor portion 12 to form the plurality of susceptor strips 16.

In the second example, in which the inductively heatable susceptor portion 12 takes the form of a plurality of concentrically arranged rings as shown in FIG. 5a, the inductively heatable susceptor portion 12 is cut into at least two parts to form the inductively heatable susceptor sheet layers 19. As described previously, 15 each sheet layer 19 comprises at least two strips of inductively heatable susceptor material 16 located between the first and second layer of aerosol generating material 15, 13.

In the third example, in which in which the inductively heatable susceptor portion 12 takes the form of a plurality of distinct parts, the inductively heatable susceptor portion 12 is divided into a plurality of parts to form the inductively heatable susceptor sheet segments 21, as shown in FIG. 5b. As described previously, each sheet segment 21 comprises at least one strip of inductively heatable susceptor material 16 located between the first and second layer of aerosol generating material 15, 13.

It should be noted that in the case of the first example, in which the inductively heatable susceptor portion 12 takes the form of a spiral, no cutting is required.

The inductively heatable susceptor portion 12 (which is in the form of e.g. a sheet, at least two sheet layers, a plurality of sheet segments) are conveyed to the rod forming unit 56 where they are formed into a continuous rod 88, as can be seen in FIG. 2. A continuous sheet of wrapping paper (not shown) is supplied to the rod forming unit 56 from a supply reel (not shown) which can be positioned downstream of the rod forming unit 56. As the sheet of wrapping paper is transported and guided through the rod forming unit 56 it is wrapped around the inductively heatable susceptor portion 12 so that the continuous rod 88 is circumscribed by a wrapper 14.

The continuous rod 88 circumscribed by a wrapper 14 is then transported to the rod cutting unit 58 where it is cut at appropriate positions into predetermined lengths to form multiple aerosol generating articles 1. The continuous rod 88 is preferably cut repeatedly by the rod cutting unit

Further units (not shown) may be arranged downstream of the rod cutting unit 58 and may be configured to provide one or more additional components such as the mouthpiece segment 20 described above and to assemble these with the individual aerosol generating articles 1 formed by the rod cutting unit 56 to form finished aerosol generating articles 1. In this case, a separate wrapping unit may be provided downstream of the rod cutting unit 58 so that the assembled components can be simultaneously wrapped to form the finished aerosol generating articles 1. The further units may form part of the apparatus 30 or may be separate, stand-alone, units forming part of a final assembly line.

Although exemplary embodiments have been described in the preceding paragraphs, it should be understood that various modifications may be made to those embodiments without departing from the scope of the appended claims. Thus, the breadth and scope of the claims should not be limited to the above-described exemplary embodiments.

Any combination of the above-described features in all possible variations thereof is encompassed by the present disclosure unless otherwise indicated herein or otherwise clearly contradicted by context. IN THE CLAIMS

1. An aerosol generating article comprising:
a first layer of aerosol generating material;
a second layer of aerosol generating material; and
a plurality of strips of inductively heatable susceptor material;
wherein each of the plurality of strips of inductively heatable susceptor material is located between the first and second layers of aerosol generating material to form an inductively heatable susceptor portion; and
wherein the inductively heatable susceptor portion is arranged to form at least one air channel.

2. The aerosol generating article according to claim h wherein the plurality of strips of inductively heatable susceptor material located between the first and second layers of aerosol generating material are arranged as a sheet.

3. The aerosol generating article according to or claim 2, wherein the sheet comprises a first surface having a plurality of raised portions.

4. The aerosol generating article according to claim 2, the sheet is arranged as a spiral.

5. The aerosol generating article according to claim 2, wherein the sheet comprises at least two sheet layers, wherein each of the at least two sheet layers comprises at least two of the plurality of strips of inductively heatable susceptor material located between the first and second layers of aerosol generating material.

6. The aerosol generating article according to claim 5, wherein each of the at least two sheet layers is arranged as a ring.

7. The aerosol generating article according to claim k wherein the rings are concentrically arranged.

8. The aerosol generating article according to claim 2, wherein the sheet comprises a plurality of sheet segments, wherein each of the plurality of sheet segments comprises at least one of the plurality of strips of inductively heatable susceptor material located between the first and second layers of aerosol generating material.

9. The aerosol generating article according to claim 8, wherein each of the plurality of sheet segments is separate from each other.

10. The aerosol generating article according to claim 9, wherein each of the plurality of sheet segments is randomly arranged within an aerosol generating device.

11. The aerosol generating article according to claim 1, wherein the aerosol generating material of at least one of the first and second layers comprises a tobacco material.

12. A method of producing an aerosol generating article comprising:
arranging a plurality of strips of inductively heatable susceptor material between first and a second layers of aerosol generating material.

13. The method of claim 1Z further comprising:
applying an adhesive to the plurality of strips of inductively heatable susceptor material;
locating the plurality of strips of inductively heatable susceptor material between the first and second layers of aerosol generating material; and
pressing the first and second layers together to form a sheet.

14. The method according to claim 13, further comprising cutting the sheet into a plurality of sheet segments, wherein each of the plurality of sheet segments comprises at least one strip of inductively heatable susceptor material located between the first and second layers of aerosol generating material.

15. The method according to claim 13, further comprising cutting the sheet into at least two sheet layers, wherein each of the at least two sheet layers comprises at least two strips of inductively heatable susceptor material located between the first and second layers of aerosol generating material.
